(19) United States
(12) Patent Application Publication
(10) Pub. No.: US 2022/0058973 A1
(43) Pub. Date: Feb. 24, 2022

(54) Recommendation Engine Guided Learning

(71) Applicant: Disney Enterprises, Inc., Burbank, CA (US)

(72) Inventors: Sonia Doshi, Los Angeles, CA (US); Lori L. Huck, Los Angeles, CA (US); Erika Varis Doggett, Los Angeles, CA (US); Paige E. Townsend, La Crescenta, CA (US)

(21) Appl. No.: 16/998,471

(22) Filed: Aug. 20, 2020

(51) Int. Cl. G09B 5/06; G06F 16/9535; G06F 21/31

(52) U.S. Cl. CPC G09B 5/065; G06F 21/31; G06F 16/9535

(57) ABSTRACT

A system performing guided user training includes a computing platform having a hardware processor and a memory storing a software code including a training recommendation engine. The hardware processor executes the software code to receive a login input from a user, identify, using the login input, a role type including the user, and determine, using the role type, one or more core competencies for the user. The software code further identifies, using the training recommendation engine, training resources for use in attaining the one or more core competencies, and generates, using the training recommendation engine and the user training profile, one or more learning playlists for attaining each of the core competencies using at least some of the identified training resources.

### BACKGROUND

Conventional approaches to employee training in the corporate environment tend to be reactive rather than proactive for several reasons. For instance, it can be difficult and time consuming to identify core competencies that a large organization may need to develop in its employees. Moreover, it is typically easier to offer introductory training or bulk learning resources at scale than to provide long-term individually curated training. In addition, for some organizations, particularly those in technology intensive industries, training needs often change rapidly along with industry changes, making it difficult to predict what specific skills are worth investing in. However, when training fails to address the particular learning needs of an employee, it is less likely that the employee will pursue that training, or engage effectively with it if it is mandated, which can result in wasted investment.

Short-term workshops or introductory training often provide only surface-level knowledge about a topic, rather than imparting a deeper understanding that an employee can apply to their own work. By contrast, for meaningful learning to occur, individual employees need to be able to participate in the identification of their own training pathways, as well as to transfer newly acquired skills to novel situations. Organizations are at risk of losing some of their most curious, ambitious, and potentially productive personnel if they do not provide them with a strategic, employee driven approach for learning.

### SUMMARY

There are provided systems and methods for providing recommendation engine guided learning, substantially as shown in and described in connection with at least one of the figures, and as set forth more completely in the claims.

### BRIEF DESCRIPTION OF THE DRAWINGS

FIG. 1 shows an exemplary system for providing recommendation engine guided learning, according to one implementation;

FIG. 2 shows a more detailed exemplary representation of a graphical user interface (GUI) provided by the software code of the system shown in FIG. 1, according to one implementation;

FIG. 3A shows a flowchart presenting an exemplary method for providing recommendation engine guided learning, according to one implementation;

FIG. 3B shows a flowchart presenting an exemplary method for providing recommendation engine guided learning, according to another implementation; and

FIG. 3C shows a flowchart including additional actions for extending the methods outlined in FIGS. 3A and 3B.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application discloses systems and methods for providing recommendation engine guided learning that address and overcome the drawbacks and deficiencies in the conventional art. The present guided learning solution advances the state-of-the-art by providing a user with learning playlists tailored to that user's needs and aspirations. As defined for the purposes of the present application., a “learning playlist” is a curated menu of learning experiences involving a variety of mediums, such as online courses, in-person workshops, expert resources, books, articles, video, and the like, that target a specific competency.

It is noted that, as used in the present application, the expression“online courses” refers to remote learning experiences that may be participatory, or may simply include educational content provided for passive consumption by a user, and that may be made available to single user or may be delivered to multiple users concurrently. By contrast, the expression “in-person workshops” refers to in situ learning experiences in which a group of users interact with one another and an instructor to acquire a skill or to consolidate knowledge. It is further noted that the expression “expert resources” refers to person-to-person interaction with an established expert in a field that includes a particular competency, as well as learning resources recommended by such an expert.

The learning playlists are designed to offer long-term learning experiences that dynamically adapt to the changing needs of an organization by defining one or more core competencies for the user inputs, such as a job description for the user's position organization, as well as desired competencies selectable by the user. The learning playlists are curated by defining a prioritized list of core competencies identified from an analysis of job descriptions and user input of their desired competencies and matching these to corresponding, best fit learning resources. In some implementations, the learning playlists can be further refined through user reviews and preferences as the user engages with the learning playlists, making the present guided learning solution unique in offering a digital learning experience that advantageously provides meaningful, relevant, and transferable learning that is strategic in driving an organization's growth.

In some implementations, the systems and methods disclosed by the present application may be substantially or fully automated. It is noted that, as used in the present application, the terms “automation” “automated,” and “automating”refer to systems and processes that do not require the participation of a human administrator. Although, in some implementations, a human training administrator may review the learning playlists generated by the automated systems and according to the automated methods described herein, or may participate in the production of such learning playlists, that human involvement is optional. Thus, in some implementations, the methods described in the present application may be performed under the control of hardware processing components of the disclosed automated systems.

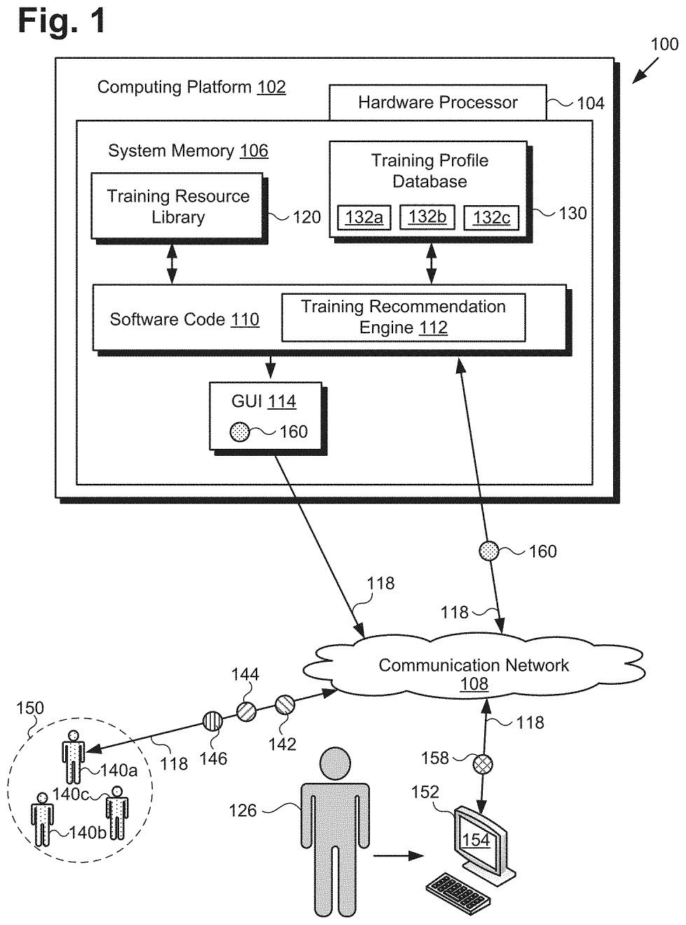

FIG. 1 shows an exemplary system for providing recommendation engine guided learning, according to one implementation. As shown in FIG. 1, system 100 includes computing platform 102 having hardware processor 104 and system memory 106 implemented as a non-transitory storage device. According to the present exemplary implementation, system memory 106 stores training resource library 120, training profile database 130, and software code 110 including training recommendation engine 112. Also shown in FIG. 1 are graphical user interface (GUI) 114 provided by software code 110, one to or more learning playlists 160 (hereinafter “learning playlist(s) 160”) displayed via GUI 114, user 140a of system 100, training profile 132a of user 140a, other users 140b and 140c sharing role type 150 with user 140a, and training profiles 132b and 132c of respective other users 140b and 140c.

With respect to the expression “role type,” each member of an organization. may be classified into a generalized role type based on their position within the organization. For example, where such an organization is a business organization employing user 140a and other users 140b and 140c, each employee of that business organization may be classified into role type, such as role type 150, based on their job description. That is to say, the job description associated with user 140a may be used to assign user 140a to role type 150 including other employees of the organization, i.e., other users 140b and 140c having the same or similar job descriptions. It is further noted that although FIG. 1 depicts user 140a as being included in role type 150, that representation is merely exemplary. In other implementations, user 140a may be included in multiple role types. For example, user 140a may be included in role type 150 based on their job description, may be included in another role type based on participation in an employee committee such as a safety committee, or entertainment planning committee, and may be included in yet another role type based on their participation in a process improvement team within the organizations, such as a Six Sigma team, for instance.

As further shown in FIG. 1, system 100 is implemented within a use environment including communication network 108, training administration system 152 including display 154, and training administrator 126 using training administration system 152. In addition, FIG. 1 shows login input 142, playlist modification input 144, and certification data 146 received by system 100 from user 140a, as well as input 158 to system 100 from training administrator 126 identifying a future competency for role type 150 including user 140a. Also shown in FIG. 1 are network communication links 118 of communication network 108 interactively connecting system 100 with training administration system 152 and a communication device utilized by user 140a (communication device of user 140a not shown in FIG. 1).

It is noted that although in some implementations, as shown in FIG. 1, training resource library 120 may be stored in system memory 106, in other implementations training resource library 120 may not be included in system 100, but may merely be accessible to system 100 via communication network 108 and network communication links 118. Moreover, in some implementations in which training resource library 120 is omitted from system 100, training resource library 120 may correspond to one or more third party providers of training resources available to user 140a.

Although the present application refers to software code 110 as being stored in system memory 106 for conceptual clarity, more generally, system memory 106 may take the form of any computer-readable non-transitory storage medium. The expression “computer-readable non-transitory storage medium,” as used in the present application, refers to any medium, excluding a carrier wave or other transitory signal that provides instructions to hardware processor 104 of computing platform 102. Thus, a computer-readable non-transitory storage medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory media include, for example, optical discs, RAM, programmable read-only memory (PROM), erasable PROM (EPROM), and FLASH memory.

Moreover, although FIG. 1 depicts software code 110 and training profile database 130 as being co-located in system memory 106, that representation is merely provided as an aid to conceptual clarity. More generally, system 100 may include one or more computing platforms 102, such as computer servers for example, which may be co-located, or may form an interactively linked but distributed system, such as a cloud-based system, for instance. As a result, hardware processor 104 and system memory 106 may correspond to distributed processor and memory resources within system 100. In one such implementation, computing platform 102 may correspond to one or more web servers accessible over a packet-switched network such as the Internet, for example. Alternatively, computing platform 102 may correspond to one or more computer servers supporting a wide area network (WAN), a local area network (LAN), or included in another type of private or limited distribution network.

Although training administration system 152 is shown as a desktop computer in FIG. 1, that representation is also provided merely as an example. More generally, training administration system 152 may be any suitable mobile or stationary computing device or system that implements data processing capabilities sufficient to enable use of GUI 114, support connections to communication network 108, and implement the functionality ascribed to training administration system 152 herein. For example, in other implementations, training administration system 152 may take the form of a laptop computer, a tablet computer, or a smartphone, for example.

Display 154 of training administration system 152 may take the form of a liquid crystal display (LCD), a light-emitting diode (LED) display, an organic light-emitting diode (OLED) display, a quantum dot (QD) display, or any other suitable display screen that performs a physical transformation of signals to light. It is noted that, in some implementations, display 154 may be integrated with training administration system 152, such as when training administration system 152 takes the form of a laptop or tablet computer for example. However, in other implementations, for example where training administration system 152 takes the form of a computer tower in combination with a desktop monitor, display 154 may be communicatively coupled to, but not physically integrated with training administration system 152.

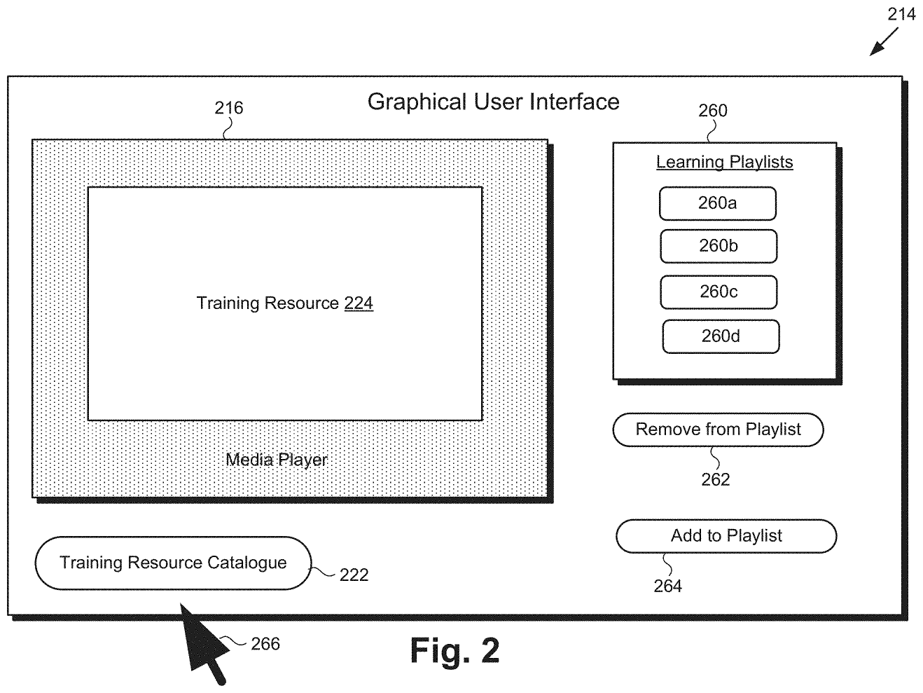

FIG. 2 shows exemplary GUI 214 provided by software code 110 of system 100, according to one implementation. As shown in FIG. 2 exemplary GUI 214 includes media player 216 playing out training resource 224 listed in one or more learning playlists 260 (hereinafter “learning playlist(s) 260”). With respect to media player 216, it is noted that the term “media player” refers to software for playing out audio, video, or animation files on a computer. Widely used examples of media players include Windows® Media Player, iTunes®, QuickTime®, and RealPlayer®, to name a few. As further shown in FIG. 2, learning playlist(s) 260 may include multiple different learning playlists 260a, 260b, 260c, and 260d, each configured to target a different core competency for a user of system 100, such as user 140a. In addition to media player 216 and learning playlists 260, GUI 214 further includes training resource catalogue 222, “remove from playlist” selector 262, “add to playlist” selector 264. Also shown in FIG. 2 is input object 266 (depicted as an exemplary cursor in FIG. 2) controlled by an input/output (I/O) device such as a mouse, keyboard, or touchscreen, for example, and usable by user 140a or training administrator 126, in FIG. 1, to interact with GUI 214.

It is further noted that although media player 216 may be used to consume training resources in the form of audio, video, and digital books or articles stored in training content library 120, or those training resources may be displayed on GUI 214 as links directly to the content source. That is to say, not all training resources accessible through GUI 214 need to be stored in training resource library 120 and hosted by system 100. With respect to playlists 260a, 260b, 260c, and 260d, it is noted that, because the same training resource may have relevance to more than one core competency, that same training resource may be listed in more than one learning playlist generated for user 140a. However, in some implementations, system 100 is configured to prevent the same training resource to be listed in more than one learning playlist targeted to the same core competency.

GUI 214 and learning playlist(s) 260 correspond respectively in general to GUI 114 and learning playlist(s) 160, in FIG. 1. That is to say, GUI 114 and learning playlist(s) 160 may share any of the characteristics attributed to respective GUI 214 and learning playlist(s) 260 by the present disclosure, and vice versa. Thus, although not shown in FIG. 1, GUI 114 may include media player 216, training resource catalogue 222, “remove from playlist” selector 262, “add to play⁻list” selector 264, and input object 266.

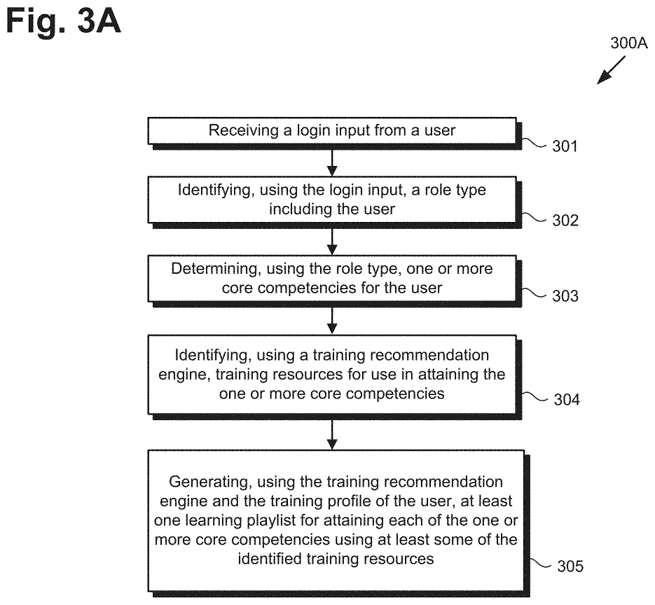

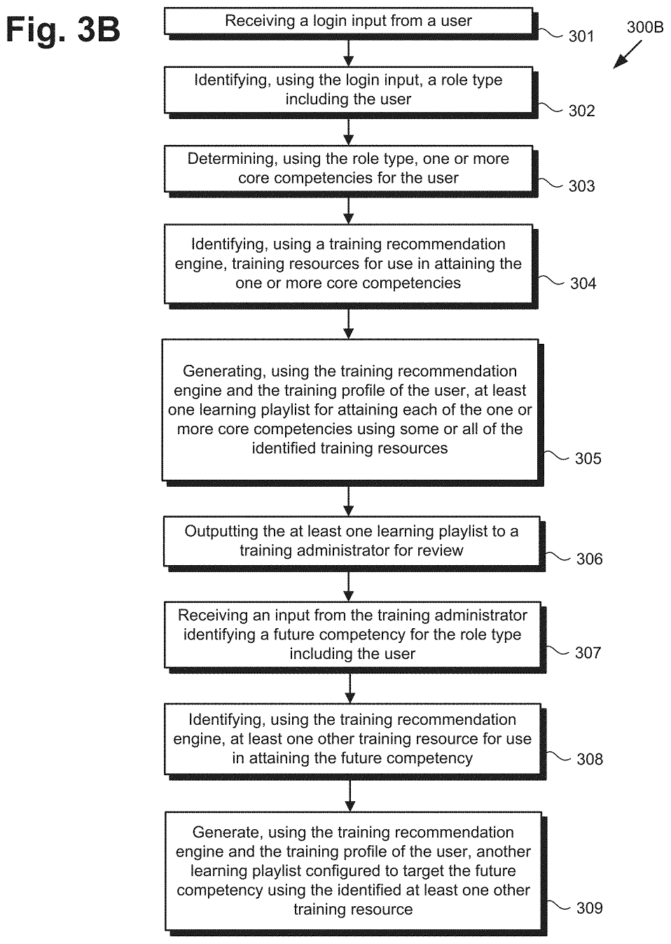

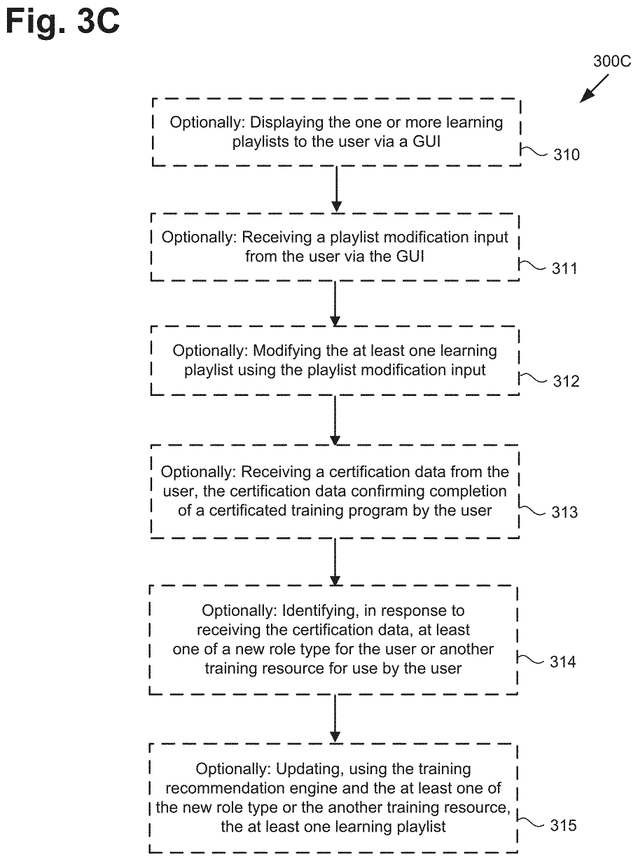

The functionality of software code 110, in FIG. 1, will be further described by reference to FIGS. 3A, 3B, and 3C. FIG. 3A shows flowchart 300A presenting an exemplary method for providing recommendation engine guided learning, according to one implementation, while FIG. 3B shows flowchart 300B presenting such a method according to another exemplary implementation. FIG. 3C shows flowchart 300C including additional actions for extending the methods outlined in FIGS. 3A and 3B. With respect to the methods outlined by FIGS. 3A, 3B, and 3C, it is noted that certain details and features have been left out of flowcharts 300A, 300B, and 300C in order not to obscure the discussion of the inventive aspects disclosed in the present application. It is further noted that although the methods and systems disclosed by the present application may be adapted for use in a wide variety of organizational settings, such as educational institutions, hospitals, government agencies, and corporations, to name a few, the methods outlined by flowcharts 300A, 300B, and 300C are described below by reference to the non-limiting use case in which user 140a is an employee of a large business organization.

Referring to FIG. 3A in combination with FIG. 1, flowchart 300A begins with receiving login input 142 from user 140a (action 301). For example, where user 140a works for a large business organization utilizing system 100 to guide the workplace training of its employees, user 140a would typically be issued an employee account and login credentials for that account. Thus, action 301 may occur due to submission of login input 142 including those login credentials uniquely identifying user 140a to system 100. As shown by FIG. 1, in one implementation, login input 142 may be received from user 140a by system 100 via communication network 108 and network communication links 118. In those implementations, g input 142 may be received by software code 110, executed by hardware processor 104 of computing platform 102.

Continuing to refer to FIGS. 1 and 3A, flowchart 300A continues with identifying using login input 142, role type 150 including user 140a (action 302). By way of example, and as noted above, each employee of the business organization for which user 140a works may be classified into a generalized role type, such as role type 150, based on their position within the organization. The job description associated with user 140a may be used to assign user 140a to role type 150 including other employees of the organization, other users 140b and 140c having the same or similar job descriptions. As further noted above, in some instances user 140a may be included in more than one role type. In those use cases, action 302 may include enabling selection of a particular role type by user 140a, GUI 114/214, for example, or may include an automated process for identifying role type 150 based predetermined criteria such as role type priority, or training deadlines, for example.

Identification of role type 150 including user 140a may be performed by software code 110, executed by hardware processor 104 of computing platform. Software code 110 may use information included in login input 142 to access training profile 132a of user 140a, which is stored in training profile database 130 of system 100. Training profile 132a of user 140a may include the job description associated with user 140a, role type 150 to which user 140a has been assigned, as well as a training history for user 140a.

Flowchart 300A continues with determining, using role type 150, one or more core competencies for user 140a (action 303). The job description associated with user 140a and stored in training profile 132a of user 140a, together with job descriptions of other users 140b and 140c included in role type 150 can be used to assemble a list of one or more competencies for user 140a. Moreover, those competencies may be hierarchically ranked based on the extent to which a particular competency is shared among other users 140b and 140c included in role type 150. For example, if user 140a and other users 140b and 140c are software engineers and use of programming language “A” is listed in more than fifty percent of the job descriptions associated with role type 150, proficiency in programming language “A” may be ranked higher, i.e., be prioritized, over other competencies appearing in less than fifty percent of those job descriptions.

In some use cases, it may be advantageous or desirable to limit the number of competencies addressed concurrently in the training of user 140a in order not to overwhelm or discourage user 140a. In those use cases, the hierarchical ranking described above may be utilized to determine that a predetermined and configurable number of the highest ranked competencies are the core competencies for user 140a in action 303. In some implementations, the proficiency of a particular user with respect to a core competency may affect the hierarchical ranking described above. For instance, in the example described above in which user 140a and other users 140b and 140c are software engineers and competence in the use of programming language “A” is determined to be a core competency for role type 150, that determination may be overridden for user 140a if user 140a has performed at or above a predetermined competency threshold on a test of proficiency in the use of programming language “A”. This may enable further personalization for users starting with the organization at different levels of personal competency and thereby advantageously facilitate the acquisition of other core competencies by those users.

Action 303 may be performed by software code 110, executed by hardware processor 104 of computing platform 102, and using training profile 132a of user 140a, as well as training profiles 132b and 132c of other users 140b and 140c included in role type 150. In some implementations, action 303 may be performed in an entirely automated process by software code 110, executed by hardware processor 104. However, in other implementations, the competencies for user 140a identified by software code 110 may be reviewed by training administrator 126 for completeness, and the one or more core competencies determined in action 303 may be reviewed for approval or correction.

Flowchart 300A continues with identifying, using training recommendation engine 112, training resources for use in attaining the one or more core competencies for user 140a (action 304). As noted above, the training resources for use by user 140a may include training resources in a variety of mediums, such as in-person workshops, expert resources, books, articles, and video, to name a few examples. The training resources for use in attaining the one or more core competencies for user 140a may be identified from among the training resources stored on training resource library 120 or otherwise available user 140a. As noted above, although in some implementations, as shown in FIG. 1, training resource library 120 may be stored in system memory 106, in other implementations training resource library 120 may riot be included in system 100, but may merely be accessible to system 100 via communication network 108. Moreover, in some implementations in which training resource library 120 is omitted from system 100, training resource library 120 may correspond to one or more third party providers of training resources available to user 140a.

Each training resource available to user 140a may be analyzed using training recommendation engine 112 to identify the best fit to the one or more core competencies determined in action 303. For example, in implementations in which training resource library 120 corresponds to one or more third party providers, all training resources available from each third party provider could be aggregated into a pool, and tagged with a provider identification and the medium in which the training resource is available. In addition, provider-specific application programming interfaces (APIs), for instance, could be used to access training resources in the pool in order to identify any training resource from any provider that matches or otherwise aligns with the core competencies for user 140a. The matching or aligned training resources can then be ranked in priority order based on various criteria, such as a training history of user 140a included in training profile 132a of user 140a, or known learning preferences of user 140a stored in training profile 132, for example.

Known learning preferences of user 140a may be based on previous engagement of user 140a with other training resources. For instance, if user 140a is more likely to watch video based content than to read article based content, that known learning preference could be used to prioritize the matching or aligned training resources identified in action 304. That is to say system 100 can learn from a user's engagement and adjust the training resource recommendations based on factors such as training resource medium, training resource duration, and the source or provider of the training resource. In some implementations, system 100 may enable user 140a to input their own preferences by medium, duration, or provider. Although those user inputs will typically not limit the training resources identified in action 304 to only those preferred by the user, the user inputs may be advantageously used to prioritize certain training resources over others.

Action 304 may be performed by software code 110, executed by hardware processor 104 of computing platform 102, and using training recommendation engine 112. In some implementations, training recommendation engine 112 may be configured to use a content-based filtering strategy to identify training resources for use in attaining the one or more core competencies for user 140a. Alternatively, or in addition, in some implementations, training recommendation engine 112 may be configured to use a collaborative filtering strategy to identify the best fit resources. For example, in some implementations, hardware processor 104 may execute software code 110 to use training recommendation engine 112 to identify the training resources for use in attaining the one or more core competencies for user 140a based on training profile 132b of other user 140b, or on training profile 132c of other user 140c. Thus, in some implementations, training recommendation engine 112 may be a hybrid. recommendation engine. Hybrid recommendation engines are described in detail in the publication titled “Hybrid Recommender System: A Systematic Literature Review,” by Erion Çano and Maurizio Morisio (arXiv:1901.03888v1 [cs.IR], Jan. 12, 2019), which is hereby incorporated fully by reference into the present application.

According to the exemplary method outlined in FIG. 3A, in some implementations, flowchart 300A can continue and conclude with generating, using training recommendation engine 112 and training profile 132a of user 140a, learning playlist(s) 160/260 for attaining each of the one or more core competencies for user 140a using at least some of the training resources identified in action 304 (action 305). Learning playlist(s) 160/260 may be generated by training recommendation engine 112 subject to one or more predetermined rules. For example, the total number of training resources included in any one of learning playlists 260a, 260b, 260c, or 260d may be limited to be less than or equal to a specific number. Alternatively, or in addition, in implementations in which training resource library 120 corresponds to one or more third party providers of training resources, the number of training resources from each provider may be limited to less than or equal to a specific number. As yet another alternative, or in addition, the number of training resources presented in each available medium may be capped, or the number of medium types included in any one of learning playlists 260a, 260b, 260c, or 260d may be capped. Action 305 may be performed by software code 110, executed by hardware processor 104 of computing platform 102, and using training recommendation engine 112. It is noted that in some implementations, actions 304 and 305 may be performed in an entirely automated process by software code 110, executed by hardware processor 104. It is further noted that although flowchart 300A lists action 305 subsequent action 304, that representation is merely exemplary. In various implementations, action 305 may follow action 304 or may be performed substantially concurrently with action 304. Thus, in some implementations, actions 301, 302, 303, 304, and 305 (hereinafter “actions 301-305”) may be performed in an automated process from which participation of training administrator 126 may be omitted. However, in some implementations in which action 304 precedes action 305, the training resources identified using training recommendation engine 112 in action 304 may be sent to training administrator 126 for review and approval before action 305 is performed.

Referring to flowchart 300B, in FIG. 3B, flowchart 300B outlines another exemplary method for providing recommendation engine guided learning. It is noted that actions 301-305 in flowchart 300B are identical to actions 301-305 in flowchart 300A described above. Consequently, the discussion of the method outlined by flowchart 300B below omits further description of actions 301-305.

According to the exemplary method outlined by flowchart 30013, action 305 is followed by outputting learning playlist(s) 160/260 to training administrator 126 for review (action 306). Action 306 may be performed by software code 110, executed by hardware processor 104 of computing platform 102. For example, learning playlist(s) 160/260 may he transmitted to training administration system 152 via communication network 108 and network communication links 118 for rendering and presentation to training administrator 126 on display 154.

Flowchart 300B continues with receiving input 158 from training administrator 126 identifying a future competency for role type 150 including user 140a (action 307). As shown in FIG. 1, training administrator 126 may utilize training administration system 152 to transmit input 158 to system 100 via communication network 108 and network communication links 118. The future competency for role type 150 may be a competency need identified by the organization employing user 140a due to actual industry changes, or due to strategic planning. In addition to identifying the future competency for role type 150 including user 140a, in some implementations, input 158 may include a priority weighting for the future competency relative to the one or more core competencies determined in action 303. Input 158 may be received in action 307 by software code 110, executed by hardware processor 104 of computing platform 102.

Flowchart 300B continues with identifying, using training recommendation engine 112, one or more other training resources for use in attaining the future competency identified by input 158 (action 308). Identification of the one or more other training resources for attaining the future competency may be performed by software code 110, executed by hardware processor 104 of computing platform 102, and using training recommendation engine 112 in a manner analogous to action 304 described above.

Flowchart 300B can conclude with generating, using training recommendation engine 112 and training profile 132a of user 140a, another learning playlist, that other learning playlist configured to target the future competency using the one or more other training resources identified in action 308 (action 309).

It is noted that in some implementations, actions 308 and 309 may be performed in an entirely automated process by software code 110, executed by hardware processor 104. It is further noted that although flowchart 300B lists action 309 subsequent to action 308, that representation is merely exemplary. In various implementations, action 309 may follow action 308 or may be performed substantially concurrently with action 308. Moreover, in some implementations in which action 308 precedes action 309, the one or more other training resources identified using training recommendation engine 112 in action 308 may be sent to training administrator 126 for review and approval before action 309 is performed.

Referring to FIG. 3C, FIG. 3C shows flowchart 300C including additional optional actions for extending the methods outlined in FIGS. 3A and 3B. Flowchart 300C can begin with displaying learning playlist(s) 160/260 to user 140a via GUI 114/214 (action 310). Optional action 310 may follow directly from action 305 when the method shown in FIG. 3A is performed. Alternatively, in use cases in which the method shown in FIG. 3B is performed, optional action 310 may follow action 309. As shown by FIG. 2, GUI 214 may display learning playlist 260 in priority order from top to bottom, i.e., learning playlist 260a taking priority over learning playlist 260b, which in turn takes priority over learning playlist 260c, and so forth.

As further shown in FIG. 2, in some implementations, GUI 214 enables a user to utilize media player 216 of GUI 214 to play out training resource 224, as well as to request additional training resources using input object 266 and “add to playlist” selector 264, request that a training resource be removed from learning playlist(s) 260 using input object 266 and “remove from playlist” selector 262, and browse training resource catalogue 222. Action 310 may be performed by software code 110, executed by hardware processor 104 of computing platform 102, via GUI 114/214 provided by software code 110.

Referring to FIG. 3C in combination with FIGS. 1 and 2, flowchart 300C can continue with optionally receiving playlist modification input 144 from user 140a via GUI 114/214 (action 311). Playlist modification input 144 may request addition of one or more user requested training resources to learning playlist(s) 160/260. Alternatively, or in addition, playlist modification input 144 may request removal of one or more training resources presently listed in learning playlist(s) 160/260. As yet another alternative, or in addition, playlist modification input 144 may request reprioritizing and reordering of learning playlists 260a, 260b, 260c, and 260d. As shown by FIG. 1, in one implementation, playlist modification input 144 may be received from user 140a by system 100 via communication. network 108 and network communication links 118. In those implementations, playlist modification input 144 may be received by software code 110, executed by hardware processor 104 of computing platform 102.

In implementations in which optional action 311 is performed, flowchart 300C may continue with optionally modifying one or more of learning playlist(s) 160/260 using playlist modification input 144 (action 312). As noted above, in some implementations, playlist modification input 144 may request addition of one or more user requested training resources to learning playlist(s) 160/260. In those implementations, hardware processor 104 of computing platform 102 may be configured to execute software code 110 to verify that user 140a is eligible to receive the user requested training resource, and modify, in response to verifying that user 140a is eligible to receive the user requested training resource, one or more of learning playlist(s) 160/260 to list the user requested training resource.

In some implementations, verification that user 140a is eligible to receive the user requested training resource identified by playlist modification input 144 may be performed by software code 110 in an automated process, by reference to training profile 132a of user 140a, for example, which may include a list of training resources to which user 140a is authorized access. However, in other implementations, verification that user 140a is eligible to receive the user requested training resource may include querying training administrator to 126 for permission to add the user requested training resource to one or more of learning playlist(s) 160/260.

As further noted above, in some implementations, playlist modification input 144 may request removal of one or more training resources presently listed in learning playlist(s) 160/260. In those implementations, hardware processor 104 of computing platform 102 may is be configured to execute software code 110 to confirm that one or more of the training resources requested to be removed has/have been completed by user 140a or is/are unrelated to the one or more core competencies for user 140a determined in action 303. Moreover, in those implementations, hardware processor may also execute software code 110 to modify, in response to confirming that the one or more training resources has/have been completed by user 140a or is/are unrelated to the one or more core competencies for user 140a, one or more of learning playlist(s) 160/260 to omit the one or more training resources requested to be removed.

In some implementations, confirmation that the one or more training resources identified by playlist modification input 144 for removal from learning playlist(s) 160/260 has/have been completed by user 140a or is/are unrelated to the one or more core competencies for user 140a may be performed by software code 110 in an automated process, by reference to training profile 132a of user 140a, which may include a training history of user 140a as well as the one or more core competencies determined in action 303. However, in other implementations, confirmation that the one or more training resources identified by playlist modification input 144 for removal from learning playlist(s) 160/260 is/are unrelated to the one or more core competencies for user 140a may include querying training administrator 126 for such confirmation.

As also noted above, in some implementations, playlist modification input 144 may request the reprioritizing of individual learning playlists 260a, 260b, 260c, and 260d listed among learning playlist(s) 160/260. In those implementations hardware processor 104 of computing platform 102 may be configured to execute software code 110 reprioritize learning playlists 260a, 260b, 260c, and 260d. In some such implementations, software code 110 may make some or all of the reprioritizing changes identified in playlist modification input 144 in an automated process, based on permissions included in training profile 132a of user 140a. However in other implementations, software code 110 may query training administrator 126 for permission to perform the requested reprioritizing of learning playlists 260a, 260b, 260c, and 260d.

In some implementations, flowchart 300C can continue with optionally receiving certification data 146 from user 140a, where certification data 146 confirms completion of a certificated training program by user 140a (action 313). For example, in addition to the training provided to user 140a by the organization for which user 140a is an employee, user 140a may pursue additional learning opportunities, such as a technical certification program, or academic degree program, for instance. User 140a may be encouraged by the organization employing user 140a to submit evidence of completion of any certification programs so that the guided learning for user 140a provided by system 100 can be appropriately updated. As shown by FIG. 1, in one implementation, certification data 146 may be received from user 140a by system 100 via communication network 108 and network communication links 118. In those implementations, certification data 146 may be received by software code 110, executed by hardware processor 104 of computing platform 102.

In implementations in which optional action 313 is performed, flowchart 300C can continue with optionally identifying, in response to receiving certification data 146, at least one of a new role type for user 140a or another training resource for use by user 140a (action 314). Certification data 146 may qualify user 140a for a change in status involving a new job description or additional responsibilities. Thus in some implementations, certification data 146 may result in removing user 140a from role type 150 and assigning user 140a to another role type associated with different core competencies. Alternatively, certification data 146 may indicate that user 140a has progressed in acquiring at least one of the one or more of the core competencies determined in action 303. In those implementations, other training resources corresponding to other core competencies associated with role type 150 in which user 140a remains may be identified in action 314.

In implementations in which a new role type is identified in action 314, action 314 may be performed by software code 110, executed by hardware processor 104 of computing platform 102, in a manner analogous to that described above by reference to action 302. In implementations in which another training resource is identified in action 314, action 314 may be performed by software code 110, executed by hardware processor 104 of computing platform 102, and using training recommendation engine 112 in a manner analogous to that described above by reference to action 304.

It is noted that although flowchart 300C shows action 313 in which certification data 146 is received from user 140a as occurring subsequent to the actions listed in FIGS. 3A and 3B, that use case is merely exemplary. For example, in some implementations, certification data 146 may be received by system 100 prior to action 302, and may be used by software code 110 to identify role type 150 for user 140a.

Flowchart 300C may cor e updating one or more of learning playlist(s) 160/260 using training recommendation engine 112 and the one or more of the new role type or the other training resource identified in action 314 (action 315). Updating of one or more of learning playlist(s) 160/260 may include one or more of adding additional training resources for use by user 140a, or removing one or more existing training resources, for example. In some implementations, updating of one or more of learning playlist(s) 160/260 may include substituting an entirely different learning playlist for one or more of learning playlists 260a, 260b, 260c, and 260d included among learning playlist(s) 160/260. Action 315 may be performed by software code 110, executed by hardware processor 104 of computing platform 102, and using training recommendation engine 112 in a manner analogous to that described above by reference to action 305.

It is noted that although flowchart 300C lists action 315 subsequent to action 314, that representation is merely exemplary. In various implementations, action 315 may follow action 314 or may be performed substantially concurrently with action 314. Moreover, and as noted above, actions 310, 311, 312, 313, 314, and 315 are optional and may be performed in a different order or entirely omitted. Consequently, in various implementations, a method for providing recommendation engine guided learning may include actions 301-305, or actions 301-305 and 310, or actions 301-305, as well as actions 310, 311, and 312 (hereinafter “actions 310-312”), or actions 301-305 as well as actions 313, 314, and 315 (hereinafter “actions 313-315”), or actions 301-305 and 310, as well as actions 313-315, or actions 301-305 as well as actions 310-312 and 313-315 (hereinafter actions “310-315”). In other implementations, such a method may include actions 301-305, 306, 307, 308, and 309 (hereinafter “actions 301-309”), or actions 301-309 and 310, or actions 301-309, as well as to actions 310-312, or actions 301-309 as well as actions 313-315, or actions 301-309 and 310, as well as actions 313-315, or actions 301-309 as well as actions 310-315.

In some implementations, hardware processor 104 may further execute software code 110 to improve the performance of training recommendation engine 112 through machine learning. For example, software code 110 may track inputs to GUI 114 by training administrator 1.26 and record the extent to which training administrator 126 corrects or otherwise changes learning playlists generated using training recommendation engine 112. That information can be used as feedback to training recommendation engine 112 to better learn the training preferences of training administrator 126. Alternatively, or in addition, feedback in the form of ratings provided by user 140a in response to receiving guided learning from system 100 may be used to further improve the performance of training recommendation engine 112.

Thus, the present application discloses systems and methods for providing recommendation engine guided learning that overcome the drawbacks and deficiencies in the conventional art. As discussed above, the present guided learning solution advances the state-of-the-art by providing a user with learning playlists tailored to that user's needs and aspirations. The learning playlists are designed to offer long-term learning experiences that dynamically adapt to the changing needs of an organization by defining one or more core competencies for the user from inputs, such as a job description for the user's position in the organization, as well as desired competencies selectable by the user. The learning playlists are curated by defining a prioritized list of core competencies identified from an analysis of job descriptions and user input of their desired competencies and matching these to corresponding, best fit learning resources. In some implementations, the learning playlists can be further refined through user reviews and preferences as the user engages with the training program, making the present guided learning solution unique in offering a digital learning experience that advantageously provides meaningful, relevant, and transferable learning that is strategic in driving an organization's growth.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a computing platform including a hardware processor and a system memory;
a software code including a training recommendation engine stored in the system memory;
the hardware processor configured to execute the software code to:
receive a login input from a user;
identify, using the login input, a role type including the user;
determine, using the role type, at least one core competency for the user;
identify, using the training recommendation engine, a plurality of training resources for use in attaining the at least one core competency; and
generate, using the training recommendation engine and a training profile of the user, at least one learning playlist for attaining the at least one core competency using at least some of the identified plurality of training resources.

2. The system of claim 1, wherein the hardware processor is further configured to execute the software code to display the at least one learning playlist to the user via a graphical user interface (GUI).

3. The system of claim 2, wherein the hardware processor is further configured to execute the software code to:
receive a playlist modification input from the user via the GUI; and
modify the at least one learning playlist using the playlist modification input.

4. The system of claim 3, wherein the playlist modification input identifies a user requested training resource omitted from the identified plurality of training resources, and wherein the hardware processor is further configured to execute the software code to:
verify that the user is eligible to receive the user requested training resource; and
modify, in response to verifying that the user is eligible to receive the user requested training resource, the at least one learning playlist to include the user requested training resource.

5. The system of claim 3, wherein the playlist modification input requests removal of at least one of the identified plurality of training resources, and wherein the hardware processor is further configured to execute the software code to:
confirm that the at least one of the identified plurality of training resources has been completed by the user or is unrelated to the at least one core competency for the user; and
modify, in response to confirming that the at least one of the identified plurality of training resources has been completed by the user or is unrelated to of the at least one core competency for the user, the at least one learning playlist to omit the at least one of the identified plurality of training resources.

6. The system of claim 1, wherein the hardware processor is configured to execute the software code to use the training recommendation engine to identify at least one of the identified plurality of training resources further using a training profile of another user included in the role type including the user.

7. The system of claim 1, wherein the hardware processor is further configured to execute the software code to:
receive a certification data from the user, the certification data confirming completion of a certificated training program by the user;
identify, in response to receiving the certification data, at least one of a new role type for the user or another training resource; and
update, using the training recommendation engine and the at least one of the new role type or the another training resource, the at least one learning playlist.

8. The system of claim I, wherein the identified plurality of training resources for use in attaining the at least one core competency comprises training resources in a plurality of mediums.

9. The system of claim 8, wherein the plurality of mediums comprises at least one of online courses, in-person workshops, expert resources, books, articles, or video.

10. The system of claim 1, wherein the hardware processor is further configured to execute the software code to:
receive an input from a training administrator identifying a future competency for the role type including the user;
identify, using the training recommendation engine and the future competency, at least one other training resource for use in attaining the future competency, and
generate, using the training recommendation engine and the training profile of the user, another learning playlist configured to target the future competency using the identified at least one other training resource.

11. A method for use by a system including a computing platform having a hardware processor and a system memory storing a software code including a training recommendation engine, the method comprising:
receiving, by the software code executed by the hardware processor, a login input from a user;
identifying, by the software code executed hardware processor and using the login input, a role type including the user;
determining, by the software code executed by the hardware processor and using the role type, at least one core competency for the user;
identifying, by the software code executed by the hardware processor and using the training recommendation engine, a plurality of training resources fair use in attaining the at least one core competency; and
generating, by the software code executed by the hardware processor and using the training recommendation engine and the training profile of the user, at least one learning playlist for attaining the at least one core competency using at least some of the identified plurality of training resources.

12. The method of claim 11, further comprising displaying, by the software code executed by the hardware processor, the at least one learning playlist to the user via a graphical user interface (GUI).

13. The method of claim 12, further comprising:
receiving, by the software code executed by the hardware processor, a playlist modification. input from the user via the GUI; and
modifying, by the software code executed by the hardware processor, the at least one learning playlist using the playlist modification input.

14. The method of claim 13, wherein the playlist modification input identifies a user requested training resource omitted from the identified plurality of training resources, the method further comprising:
verifying, by the software code executed by the hardware processor, that the user is eligible to receive the user requested training resource; and
modifying, by the software code executed by the hardware processor and in response to verifying that the user is eligible to receive the user requested training resource, the at least one learning playlist to list the user requested training resource.

15. The method of claim 13, wherein the playlist modification input requests removal of at least one of the identified plurality of training resources, the method further comprising:
confirming, by the software code executed by the hardware processor, that the at least one of the identified plurality of training resources has been completed by the user or is unrelated to the at least one core competency for the user; and
modifying, by the software code executed by the hardware processor and in response to confirming that the at least one of the identified plurality of training resources has been completed by the user or is unrelated to of the at least one core competency for the user, the at least one learning playlist to omit the at least one of the identified plurality of training resources.

16. The method of claim 11, wherein the training recommendation engine identifies one of the identified plurality of training resources further using a training profile of another user included in the role type including the user.

17. The method of claim 11, further comprising:
receiving, by the software code executed by the hardware processor, a certification data from the user, the certification data confirming completion of a certificated training program by the user;
identifying, by the software code executed by the hardware processor and in response to receiving the certification data, at least one of a new role type for the user or another training resource; and
updating, by the software code executed by the hardware processor and using the training recommendation engine and the at least one of the new role type or the another training resource, the at least one learning playlist.

18. The method of claim 11, wherein the identified plurality of training resources for use in attaining the at least one core competency comprises training resources in a plurality of mediums.

19. The method of claim 18, wherein the plurality of mediums comprises at least one of online courses, in-person workshops, expert resources, books, articles, or video.

20. The method of claim 11, further comprising:
receiving, by the software code executed by the hardware processor, an input from a training administrator identifying a future competency for the role type including the user;
identifying, by the software code executed by the hardware processor and using the training recommendation engine and the future competency, at least one other training resource for use in attaining the future competency, and
generating, by the software code executed by the hardware processor and using the training recommendation engine and the training profile of the user, another learning playlist configured to target the future competency using the identified at least one other training resource.
